(19) United States
(12) Patent Application Publication
(10) Pub. No.: US 2007/0205973 A1
(43) Pub. Date: Sep. 6, 2007

(54) METHOD FOR DRIVING LCD PANELS

(76) Inventor: Chun-Yi Huang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,826

(22) Filed: May 11, 2006

(30) Foreign Application Priority Data
Mar. 1, 2006 (TW) 95106755

(51) Int. Cl. G09G 3/36

(52) U.S. Cl. 345/98

(57) ABSTRACT

A method for driving TFT LCD panels is provided. When a first output enable signal assumes a first state, turn on the N-th gate line of a TFT LCD panel so that liquid crystal capacitors turned on by the N-th gate line load an image signal. When a second output enable signal assumes the first state, turn on the (N+A)-th gate line of the TFT LCD panel so that liquid crystal capacitors turned on by the (N+A)-th gate line load a grayscale signal. The first output enable signal and the second output enable signal alternately assume the first state in every period of a horizontal synchronizing signal.

### CROSS-REFERENCE TO RELATED APPLICATION

This application claims the priority benefit of Taiwan application serial no. 95106755, filed on Mar. 1, 2006. All disclosure of the Taiwan application is incorporated herein by reference.

### BACKGROUND OF THE INVENTION

1. Field of Invention

The present invention relates to a method for driving thin-film transistor liquid crystal display panels (TFT LCD panels). More particularly, the present invention relates to a driving method imitating a pulse-type driving method.

2. Description of Related Art

FIG. 1 is a schematic view of the driving method applied in common TFT LCD panels. In this figure, G1-Gn are gate control signals, and S1-Sn are source signals. As shown in FIG. 1, pixels on a TFT LCD panels are arranged in an array. Each of the pixels is a combination of a thin-film transistor and a liquid crystal capacitor. When the thin-film transistor is turned on, an image signal charges the liquid crystal capacitor via a source line. On the other hand, when the thin-film transistor is turned off, the image signal is kept on the liquid crystal capacitor for a frame period until the liquid crystal capacitor is charged again, and then the previous display brightness of the display panel changes. Compared with the pulse-type driving method applied to cathode ray tube (CRT) display techniques, such hold-type driving method often causes image persistence due to visual persistence, such that a blur phenomenon occurs in moving images on TFT LCD panels.

In order to solve problems of image blur, draggle, or color shift when moving images are being displayed on TFT LCD panels, a driving method similar to the pulse-type driving method is provided, so that moving images on TFT LCD panels can have a favorable quality comparable to that of the CRT display techniques.

FIG. 2 is a timing diagram of the driving method similar to the pulse-type driving method of the solution described above. The horizontal axis is time, and the vertical axis is gate control signals G1-G480 of 480 gate lines. As for the control of the gate drivers, each frame period is divided into two parts. In the first half of the frame period, the liquid crystal capacitors load image signals. In the second half of the frame period, the liquid crystal capacitors load black signals. Herein, the blur phenomenon of moving images is eliminated by loading black signals. However, in this solution of dividing the frame period into two halves, for the need of loading black signals into the liquid crystal capacitors, the frequency of the horizontal synchronizing signals has to be doubled, thus resulting in an increase in the power consumption of the system and difficulty in the system design, and the charging time of the liquid crystal capacitors is undesirably shortened.

FIG. 3 is a timing diagram of a driving method similar to the pulse-type driving method of another solution described above. The horizontal axis is the time, and the vertical axis is gate control signals G1-G480 of 480 gate lines. This solution also employs a method in which the liquid crystal capacitors alternately load image signals and black signals to eliminate the blur phenomenon of moving images. Different from the solution as shown in FIG. 2, this solution adopts two sets of source drivers to respectively provide image signals and black signals, so as to maintain the original charging time of liquid crystal capacitors and the original frequency of horizontal synchronizing signals. However, as the number of source drives increases, the circuit complexity and cost are increased in this solution.

### SUMMARY OF THE INVENTION

The object of the present invention is to provide a method for driving TFT LCD panels, which imitates the pulse-type driving of CRTs to eliminate the blur phenomenon of moving images without doubling the frequency or adding an extra set of source drivers as in prior arts.

To achieve the aforementioned or other objects, the present invention provides a method for driving TFT LCD panels. The first output enable signal and the second output enable signal alternately assume the first state in accordance with every period of a horizontal synchronizing signal. When the first output enable signal assumes the first state, turn on the N-th gate line of the TFT LCD panel so that the liquid crystal capacitors turned on by the N-th gate line load an image signal. When the second output enable signal assumes the first state, turn on the (N+A)-th gate line of the TFT LCD panel so that the liquid crystal capacitors turned on by the (N+A)-th gate line load a grayscale signal, wherein N is a count value, and A is a predetermined integer.

The method for driving TFT LCD panels according to an embodiment further comprises when the second output enable signal assumes the first state, turning on the (N+A)-th to the (N+B)-th gate lines of the TFT LCD panel so that the liquid crystal capacitors turned on by the (N+A)-th to the (N+B)-th gate lines load a grayscale signal, wherein B is a predetermined integer greater than A.

According to the method for driving TFT LCD panels of an embodiment, the image signal and the gray signal are provided to the gate lines by source drivers via a plurality of source lines. When the first output enable signal assumes the first state, the source lines provide the image signal, and when the second output enable signal assumes the first state, the source lines provide the grayscale signal.

According to the preferred embodiment of the present invention, when the first output enable signal assumes the first state, the liquid crystal capacitors turned on by the N-th gate line load the image signal provided by the source lines, and when the second output enable signal assumes the first state, the liquid crystal capacitors turned on by the (N+A)-th gate line load the grayscale signal provided by the source lines. The image signal and the grayscale signal are alternately provided by the source lines. The present invention simulates the pulse-type driving method of CRTs to eliminate problems of image blur, draggle or color shift when moving images are being displayed on TFT LCD panels. In addition, compared with the prior arts, the frequency of the horizontal synchronizing signal and the number of source drivers do not have to increase in the present invention, and the blur phenomenon of moving images can be eliminated. Therefore, as compared with the prior arts, the present invention not only simplifies the circuit, but also reduces the power consumption and cost of the circuit.

In order to make aforementioned and other objects, features and advantages of the present invention comprehensible, preferred embodiments accompanied with figures are described in detail below.

### BRIEF DESCRIPTION OF THE DRAWINGS

FIG. 1 is a schematic view of the driving method applied to common TFT LCD panels.

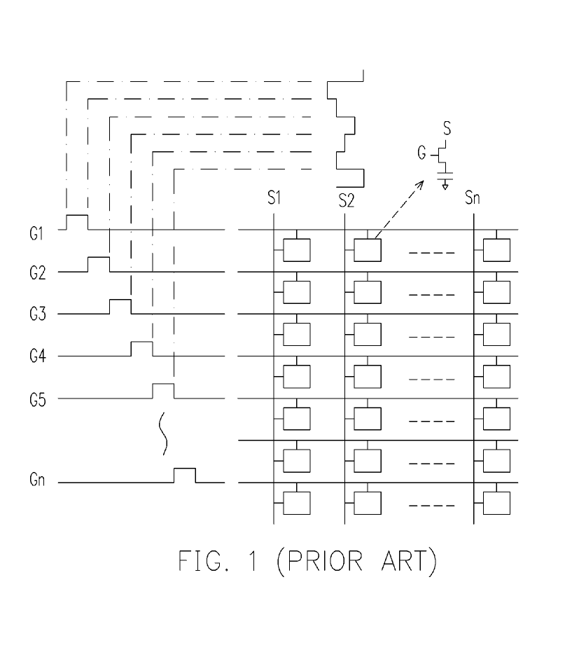

FIG. 2 is a timing diagram of a driving method similar to the pulse-type driving method of the prior arts.

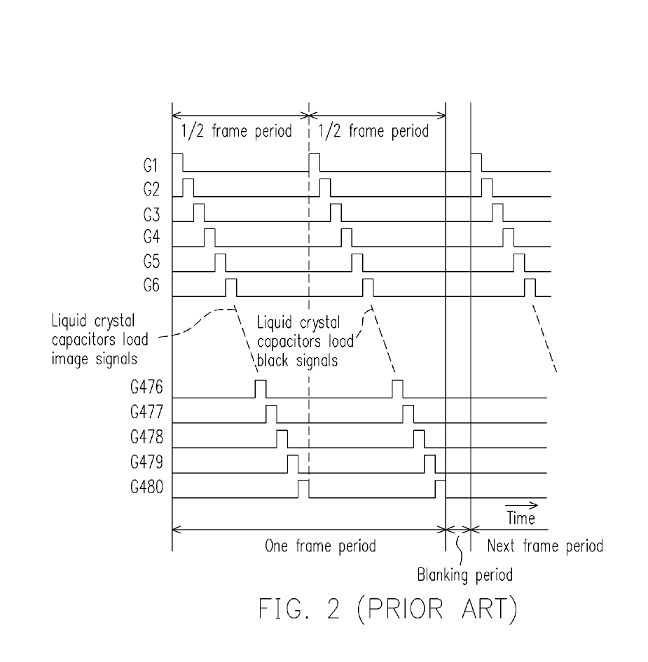

FIG. 3 is a timing diagram of another driving method similar to the pulse-type driving method of the prior arts.

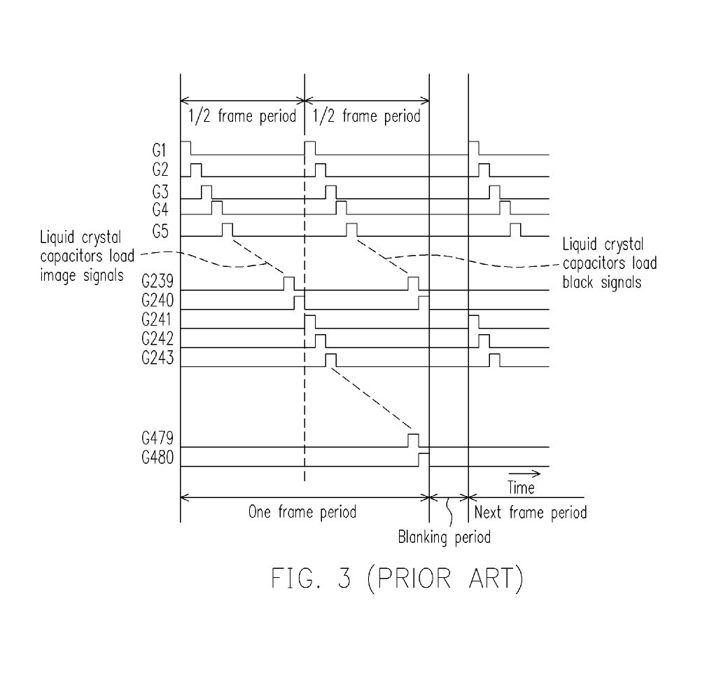

FIG. 4 is a control timing diagram of source drivers of the method for driving TFT LCD panels according to an embodiment of the present invention.

FIG. 5 is a control timing diagram of gate drivers of the method for driving TFT LCD panels according to an embodiment of the present invention.

FIG. 6 is a macro-control timing diagram according to the embodiment of the present invention as shown in FIG. 5.

FIG. 7 is a control timing diagram of gate drivers of the method for driving TFT LCD panels according to another embodiment of the present invention.

FIG. 8 is a macro-control timing diagram of the embodiment of the present invention as shown in FIG. 7.

FIG. 9 shows the voltage response of the liquid crystal on the first gate line in the embodiment of the present invention as shown in FIG. 8.

### DESCRIPTION OF EMBODIMENTS

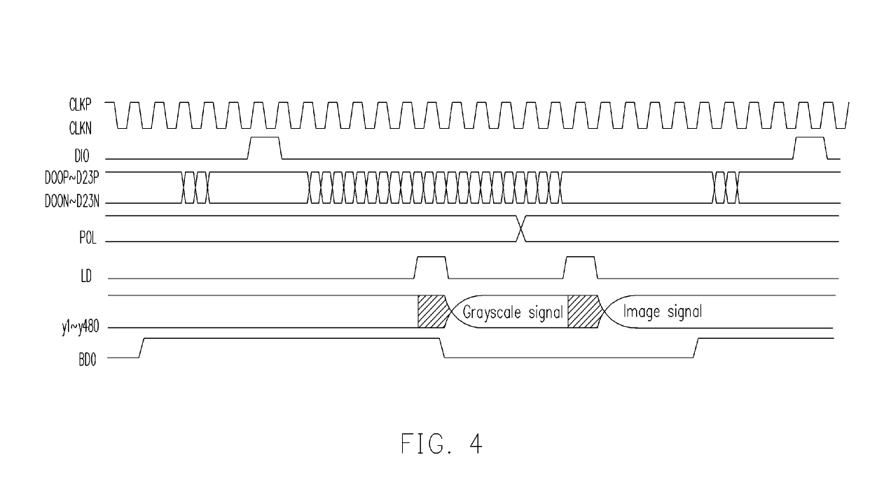

FIG. 4 is a control timing diagram of source drivers of the method for driving TFT LCD panels according to an embodiment of the present invention. As shown in FIG. 4, CLKP and CLKN are system pixel clocks. D00P/N-D023P/N are RSDS (reduced swing differential signal) differential input data. DIO is a horizontal start pulse signal to activate the source driver, such that RSDS data are sequentially stored in an internal register of the source driver. POL is a polarity control signal. LD is a download signal. y1-y480 are analog output signals of 480 channels provided by the source driver. BDO is a grayscale control signal.

Referring to FIG. 4, the source driver provides the image signal and the grayscale signal to liquid crystal capacitors via a plurality of source lines. During transmitting the signal, first, the source driver waits for two system pixel clocks after the grayscale control signal BDO becomes the preset state, and then latches the grayscale signal into the internal register of the source driver. Then, the image signal and the grayscale signal are sent to an output buffer of the source driver from the internal register of the source driver according to the download signal LD. The preset state of BDO is Logic 1, and the grayscale signal can be any grayscale from black to white. In this embodiment, the grayscale signal is a black signal. As for the design of the driving method of the panel, those skilled in the art can set the preset state of BDO to be either Logic 1 or Logic 0 as desired.

The procedure of the source driver sending the image signal and the grayscale to the output buffer from the internal register according to the download signal LD is described as follows. First, the source driver sends the grayscale signal from the internal register to the digital/analog converter of the source driver on the first edge of the download signal LD. Then, the grayscale signal is sent from the digital/analog converter to the output buffer on the second edge of the download signal LD. After that, the image signal is sent from the internal register to the digital/analog converter on the third edge of the download signal LD. Finally, the image signal is sent from the digital/analog converter to the output buffer on the fourth edge of the download signal LD. In this embodiment, the first and the third edges are rising edges, while the second and the fourth edges are falling edges. Referring to FIG. 4, the source driver of this embodiment sequentially outputs the grayscale signal and the image signal along with two pulses of the download signal LD. However, those skilled in the art can convert the first and the third edges of the download signal LD into falling edges, and convert the second and the fourth edges into rising edges as desired.

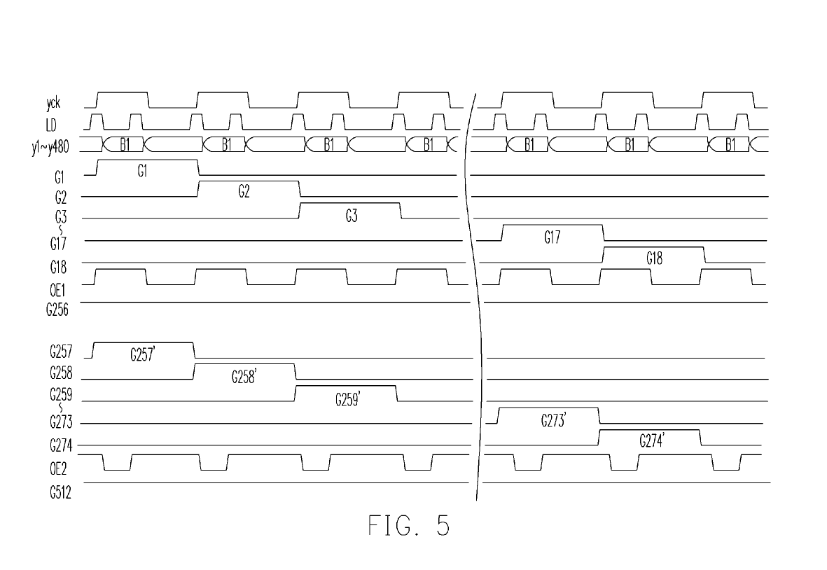

FIG. 5 is a control timing diagram of gate drivers of the method for driving TFT LCD panels of this embodiment. In the figure, yck is a horizontal synchronizing signal. G1-G256 are gate control signals provided by a first gate driver. G257-G512 are gate control signals provided by a second gate driver. And OE1 and OE2 are output enable signals of the first gate driver and the second gate driver respectively. FIG. 5 is a control timing diagram of the gate drivers accompanied with FIG. 4, so the download signal LD and the analog output signals y1-y480 of FIG. 4 are also shown in FIG. 5.

Before the timing diagram of FIG. 5 is illustrated, the background of the action of the gate driver switching the TFTs in this embodiment must be understood first. When the output enable signals (OE1/OE2) of the gate drivers are Logic 1, the gate control signals output by the gate drivers are all Logic 0. The gate drivers download the count value N from a shift register and output the control signal of the N-th gate line only when the output enable signals (OE1/OE2) of the gate drivers are Logic 0. As for a single gate line, the single gate line is turned on only when the output enable signals (OE1/OE2) are Logic 0, and the gate control signal provided to the gate line at the same time point is Logic 1, such that the liquid crystal capacitors load the signals provided by the source driver.

Referring to FIG. 5, the source driver provides the grayscale signals and the image signals (y1-y480) according to the download signal LD, such that the gate drivers alternately turn on each of the gate lines according to the gate control signals (G1-G256, G257-G512) and the output enable signals (OE1, OE2) to enable the liquid crystal capacitors to load the grayscale signals and the image signals (y1-y480). The first gate driver turns on the N-th gate line (G1-G256) of the TFT LCD panel when the first output enable signal OE1 becomes the preset state (the preset state is different from that of the grayscale control signal BDO described above), such that the liquid crystal capacitors turned on by the N-th gate line (G1-G256) load the image signal provided by the source lines. Similarly, the second gate driver turns on the (N+A)-th gate line (G257-G512) when the second output enable signal OE2 becomes the preset state, such that the liquid crystal capacitors turned on by the (N+A)-th gate line (G257-G512) load the grayscale signal provided by the source lines. In this embodiment, G_{N} refers to the gate control signal of the first output enable signal OE1, and G_{N}′ refers to the gate control signal of the second output enable signal OE2. In every period of the horizontal synchronizing signal yck, two gate lines (such as G1 and G257′) are sequentially turned on, but the respective output enable signals OE1 and OE2 of the first gate driver and the second gate driver are non-overlap at the time point of the preset state. N is a count value from the shift register. A is a predetermined positive integer, for example, 256 in this embodiment. Seen from FIG. 5, the preset states of OE1 and OE2 are Logic 0. Those skilled in the art can set the preset state to be either Logic 1 or Logic 2 as desired, and also can set A to be either a positive integer or a negative integer. FIG. 5 shows the situation when A is a positive integer, in which between turning on the two gate lines in the same period of the horizontal synchronizing signal, the gate line that enables the liquid crystal capacitors loading the image signal is positioned above the gate line that enables the liquid crystal capacitors loading the grayscale signal. If A is a negative integer, the situation is opposite.

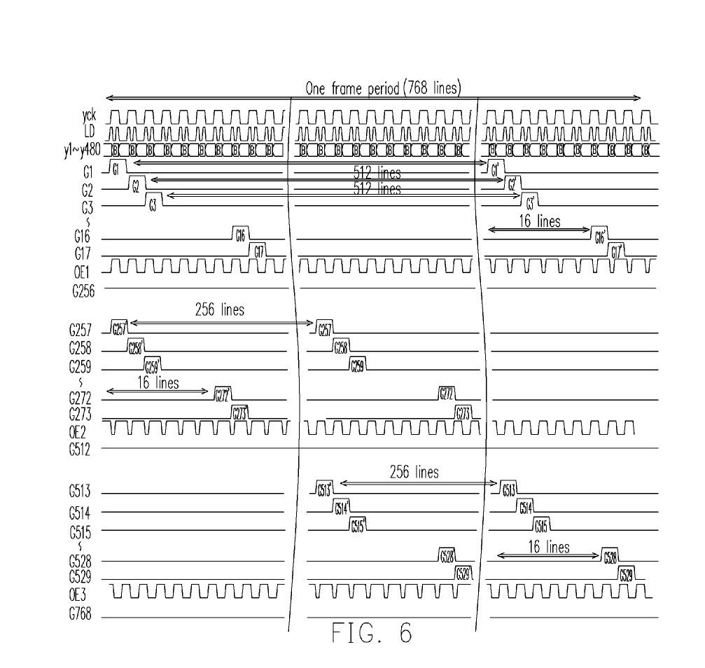

FIG. 6 is a macro control timing diagram of the embodiment as shown in FIG. 5. Gate control signals G513-G768 provided by a third gate driver and an output enable signal OE3 of the third gate driver are further marked. If one frame period goes through 768 gate lines, each gate line is turned on twice during one frame period, such as G1 and G1′, G2 and G2′ as shown in FIG. 6, such that the liquid crystal capacitors alternately load the grayscale signals and the image signals (y1-y480). As for the time interval between two times each gate line is turned on, in this embodiment, ⅔ frame period is used to load the image signals, and ⅓ frame period is used to load the grayscale signals. The time points at which each gate line has been turned on twice is the distance from G_{N} to G_{N}′ (N is 1-768) being 512 gate lines, and the distance from G_{N}′ to G_{N} being 256 gate lines. Therefore, as shown in FIG. 6, the distance from the gate control signal G1 provided by the first output enable signal to the gate control signal G1′ provided by the second output enable signal of the first gate driver is 512 gate lines. The distance from the gate control signal G257 provided by the second output enable signal to the gate control signal G257′ provided by the first output enable signal of the second gate driver is 256 gate lines. Two gate lines are sequentially turned on (such as G1 and G257′, G1′ and G513, G2 and G258′, G257 and G513′) in each period of the horizontal synchronizing signal as shown in FIG. 6.

The first and the second output enable signals and the output enable signals OE1-OE3 received by the gate drivers have different relations of correspondence at different time points. For example, when the first gate driver outputs the gate control signal G1, OE1 corresponds to the first output enable signal, and when outputting the gate control signal G1′, OE1 corresponds to the second output enable signal. It can be seen from FIG. 6 that when the relations of correspondence of OE1-OE3 change, the waveforms thereof are significantly different.

In FIG. 6, in every period of the horizontal synchronizing signal yck, the first and the second output enable signals alternately assume the state of Logic 0. In every embodiment of the present invention, the first output enable signal can assume the state of Logic 0 first, or the second output enable signal can assume the state of Logic 0 first.

In addition, in this embodiment, the count value N increases with each period of yck. For example, G1 and G257′ are turned on in the first period of yck, and G2 and G258′ are turned on in the second period of yck, and so forth. In other embodiments, the count value N can also decrease with each period of yck.

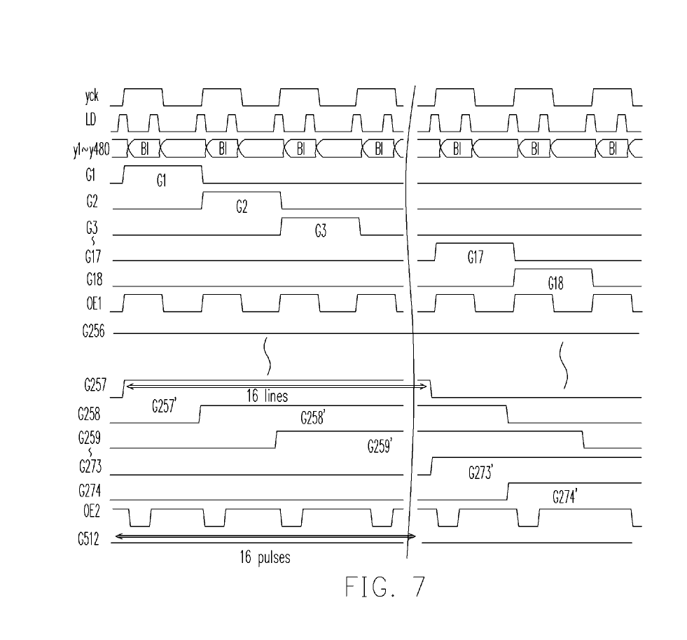

FIG. 7 is a control timing diagram of gate drivers of the method for driving TFT LCD panels of another embodiment of the present invention. Signals as shown in FIG. 7 are the same as that of FIG. 5, and the background of the action of the gate drivers switching the TFTs and the relevant timing control principle are substantially the same as that of FIG. 5. The gate drivers in both figures turn on the N-th gate line of the TFT LCD panel when the first output enable signal assumes the first state, so that the liquid crystal capacitors turned on by the N-th gate line load the image signal. The greatest difference lies in that the gate drivers turn on the (N+A)-th to the (N+B)-th gate lines of the TFT LCD panel when the second output enable signal becomes the preset state, so that the liquid crystal capacitors turned on by the (N+A)-th to the (N+B)-th gate lines load the grayscale signal, where B is a predetermined value greater than A. Therefore, in the embodiment as shown in FIG. 7, the first gate driver turns on the N-th (G1-G256) gate line of the TFT LCD panel when the first output enable signal OE1 becomes the preset state (Logic 0 in this embodiment), so that the liquid crystal capacitors turned on by the N-th (G1-G256) gate line load the image signal provided by the source lines. The second gate driver turns on the (N+241)-th to the (N+256)-th gate lines when the second output enable signal OE2 becomes the preset state, so that the liquid crystal capacitors turned on by the 16 continuous gate lines load the grayscale signal provided by the source lines. And directed to a specific gate line, in this embodiment, the liquid capacitor loads the grayscale signal under the control of the second output enable signal OE2, such that the liquid crystal capacitors continuously load the grayscale signal 16 times. Therefore the signal width of the gate control signal G_{N}′ controlled by the second output enable signal OE2 is 16 times of that of gate control signal G_{N} controlled by the first output enable signal OE1.

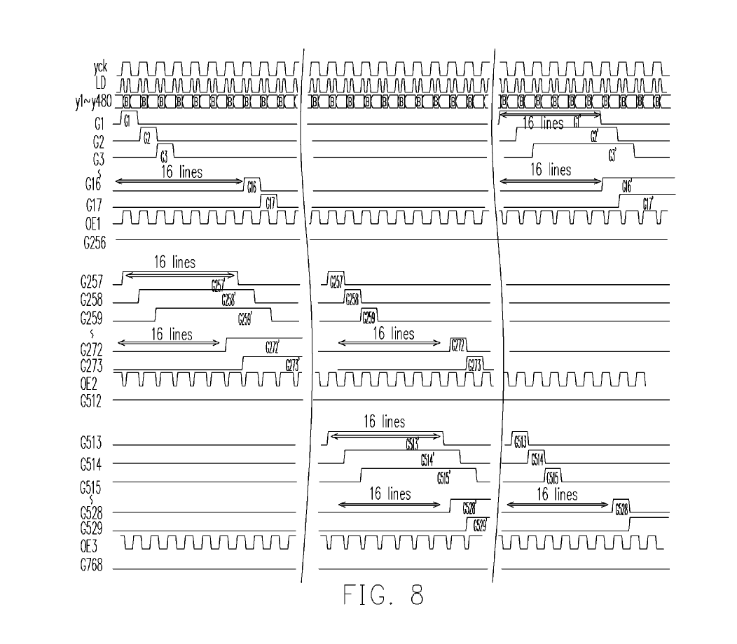

FIG. 8 is a macro control timing diagram of the embodiment as shown in FIG. 7. The gate control signals G513-G768 provided by a third gate driver and an output enable signal OE3 of the third gate driver are further marked. As for the timing control of FIG. 8, the liquid crystal capacitors turned on by each gate line must load the image signal and the grayscale signal (y1-y480). Different from the previous embodiment, the gate drivers make the liquid crystal capacitors continuously loading the grayscale signals 16 times under the control of the second output enable signal. Compared with the embodiment as shown in FIG. 6, the time period of second output enable signal when being in the preset state in this embodiment is short. However, its discharge mode is frequent low-quantity, such that the time period of the output of the image signals will not be sacrificed due to the time period of the output of the grayscale signals, and the grayscale signals and the image signals have adequate time to respond the liquid crystal capacitors.

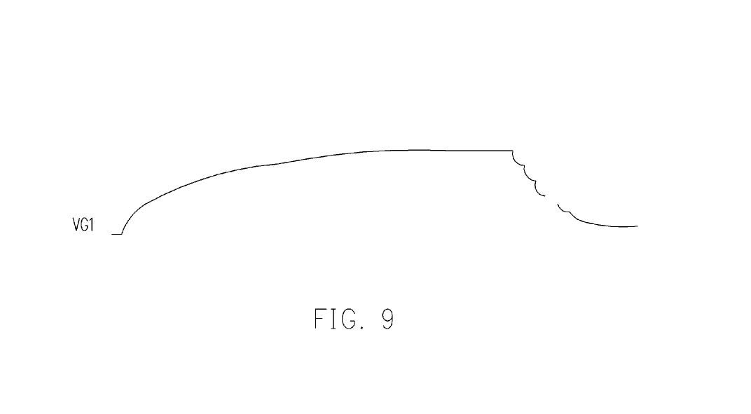

FIG. 9 shows the response of voltage VG1 in a frame period of the liquid crystal on the first gate line of the embodiment described above. When the first output enable signal becomes the preset state, the liquid crystal capacitor turned on by the first gate line loads the image signal, during which the voltage VG1 of the liquid crystal capacitor is charged from the lowest voltage to the set value in accordance with the value of the image signal. When the second output enable signal becomes the preset state, the liquid crystal capacitor turned on by the first gate line loads the grayscale signal, during which the voltage VG1 of the liquid crystal capacitor is discharged to the lowest voltage from the original set value. Thus the voltage of each pixel assumes a driving method similar to the pulse-type driving method in a frame period.

In view of the above, in the present invention, each frame period is divided into two parts, such that the gate lines can turned on each liquid crystal capacitor twice per frame to have the capacitors alternately load image signals and grayscale signals in response to the first output enable signal and the second output enable signal. Thus as each pixel assumes the image signal and the grayscale signal respectively, the voltage of each liquid crystal capacitor of each pixel assumes the behavior similar to that of a pulse-type driving method, such that the TFT LCD panels can display clear visual pictures when displaying moving images. Also, compared with the method described in the prior arts, the frequency of the signals does not need to be doubled and additional source drivers are saved, such that the power consumption and the cost can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for driving LCD panels, comprising:
when a first output enable signal assumes a first state, turning on the N-th gate line of a LCD panel so that liquid crystal capacitors turned on by the N-th gate line load an image signal; and
when a second output enable signal assumes the first state, turning on the (N+A)-th gate line of the LCD panel so that liquid crystal capacitors turned on by the (N+A)-th gate line load a grayscale signal; wherein
N is a count value, and A is a predetermined integer;
the first output enable signal and the second output enable signal alternately assume the first state in every period of a horizontal synchronizing signal; and
the count value N increases or decreases in response to the horizontal synchronizing signal.

2. The method for driving LCD panels as claimed in claim 1, further comprising:
when the second output enable signal assumes the first state, turning on the (N+A)-th gate line to the (N+B)-th gate line of the LCD panel so that liquid crystal capacitors turned on by the (N+A)-th gate line to the (N+B)-th gate line load a grayscale signal, wherein B is a predetermined integer greater than A.

3. The method for driving LCD panels as claimed in claim 1, wherein the first output enable signal assumes the first state first in every period of the horizontal synchronizing signal.

4. The method for driving LCD panels as claimed in claim 1, wherein the second output enable signal assumes the first state first in every period of the horizontal synchronizing signal.

5. The method for driving LCD panels as claimed in claim 1, wherein the first state is either Logic 1 or Logic 0.

6. The method for driving LCD panels as claimed in claim 1, wherein the count value N is from a shift register.

7. The method for driving LCD panels as claimed in claim 1, wherein A is a positive integer.

8. The method for driving LCD panels as claimed in claim 1, wherein A is a negative integer.

9. The method for driving LCD panels as claimed in claim 1, wherein the grayscale signal is a black signal.

10. The method for driving LCD panels as claimed in claim 1, wherein the image signal and the grayscale signal are provided to the liquid crystal capacitors turned on by the gate lines by a source driver via a plurality of source lines.

11. The method for driving LCD panels as claimed in claim 10, further comprising:
when the first output enable signal assumes the first state, the source lines providing the image signal; and
when the second output enable signal assumes the first state, the source lines providing the grayscale signal.

12. The method for driving LCD panels as claimed in claim 10, further comprising:
the source driver latching the grayscale signal into an internal register of the source driver after a grayscale control signal assumes a second state.

13. The method for driving LCD panels as claimed in claim 12, wherein the second state is either Logic 1 or Logic 0.

14. The method for driving LCD panels as claimed in claim 12, further comprising:
the source driver sending the image signal and the grayscale signal from the internal register to an output buffer of the source driver according to a download signal.

15. The method for driving LCD panels as claimed in claim 14, further comprising:
the source driver sending the grayscale signal from the internal register to a digital/analog converter of the source driver on a first edge of the download signal;
the source driver sending the grayscale signal from the digital/analog converter to the output buffer on a second edge of the download signal;
the source driver sending the image signal from the internal register to the digital/analog converter on a third edge of the download signal; and
the source driver sending the image signal from the digital/analog converter to the output buffer on a fourth edge of the download signal.

16. The method for driving LCD panels as claimed in claim 15, wherein the first edge and the third edge are rising edges, and the second edge and the fourth edge are falling edges.

17. The method for driving LCD panels as claimed in claim 15, wherein the first edge and the third edge are falling edges, and the second edge and the fourth edge are rising edges.

18. A method for driving LCD panels, wherein the LCD panel has a plurality of gate lines and a plurality of source lines cross-arranged and a corresponding pixel is at the intersection of each of the gate lines and each of the source lines, the method comprising:
sending a turn-on signal to the gate line at least twice in a frame period;
when the turn-on signal turns on the liquid crystal capacitor of the pixel via the gate line for the first time, the source line sending an image signal to the liquid crystal capacitor of the pixel; and
when the turn-on signal turns on the liquid crystal capacitor of the pixel via the gate line for the second time, the source line sending a grayscale signal to the liquid crystal capacitor of the pixel.

19. The method for driving LCD panels as claimed in claim 18, wherein the grayscale signal is a black signal.
